(19) United States
(12) Patent Application Publication
(10) Pub. No.: US 2007/0259985 A1
(43) Pub. Date: Nov. 8, 2007

(54) Spray Condensation Method for the Production of Resin

(75) Inventors: Gregor Brodt, Heppenheim (DE); Moritz Ehrenstein, Ludwigshafen (DE); Marco Kruger, Mannheim (DE); Volker Seidl, Mannheim (DE); Dominik Winter, Ludwigshafen (DE); Asif Karim, Hamburg (DE); Hans-Ulrich Moritz, Bendestorf (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/574,856

(22) PCT Filed: Sep. 6, 2005
(86) PCT No.: PCT/EP05/09567

§ 371 Date: Mar. 7, 2007

(30) Foreign Application Priority Data
Sep. 8, 2004 (DE) 10 2004 043 479.4

(51) Int. Cl. C08G 12/38; B01J 2/04

(52) U.S. Cl. 521/188

(57) ABSTRACT

In the spray condensation process for the preparation of dried resins in powder form from melamine, urea or a mixture thereof and at least one aldehyde, the morphology of the resin particles produced is influenced in a targeted manner with respect to their particle parameters.

The present invention relates to a spray condensation process for the preparation of dried resins in powder form from melamine, urea or a mixture thereof and at least one aldehyde having a certain morphology.

The preparation of dried resins in powder form by means of a spray condensation process is described in the non-prior published DE 103 14466.8-43 of an earlier priority date, the condensation of at least one starting material which is liquid or dissolved in a liquid phase with at least one aldehyde being carried out in a spray reactor. The resin particles produced are present, as a rule, as solid particles in dry powder form or as liquid product or as solid product laden with residual moisture.

Spray polymerization reactions, which constitute a superposition of a polymerization process with drying in one process step, have been known for years. A wide selection of polymerization reactions is used here (cf. for example WO 96/40427 and U.S. Pat. No. 5,269,980). In general, spherical polymer particles having a predetermined and controllable particle size and monodisperse or polydisperse distribution are produced.

GB-B 949 968 describes a process for the production of very small foam particles from organic polymeric material, the polymer or the starting materials thereof being sprayed into a hot gas stream of high velocity, preferably close to the speed of sound, the temperature of which is sufficiently high to initialize the foaming or expansion of the polymer or the formation and simultaneous foaming of the polymer. The foaming can additionally be brought about by the presence of a suitable blowing agent or by the action of gases and vapors forming from the chemical reaction taking place. The hot gas stream is produced, for example, by gas turbines in order to produce the plastics aerosols. It is also mentioned that urea/formaldehyde resins can cure in such a hot stream in a foamed form. The very small particles produced are present as open or closed cells which can agglomerate to give isolated associations and have a density which can be compared with that of air. The extreme process conditions regarding temperature and gas velocity and the design of the entry of the starting materials, for example as a Venturi nozzle, permit the rapid expansion in order to influence size and density of the particles but do not permit monitoring of the morphology in a targeted manner.

It is accordingly an object of the invention to provide a simplified process for the preparation of condensed resins in powder form which makes it possible to monitor and control in a targeted manner the morphology of the resin particles in the resin powder produced.

This object is achieved starting from the known process of spray condensation for the preparation of resins in powder form from melamine, urea or a mixture thereof and at least one aldehyde. In the process according to the invention, the morphology of the resin particles produced is influenced with respect to their particle parameters during the spray condensation and/or after the latter has been carried out.

The influencing in a targeted manner is effected substantially by varying process parameters, which are of a material nature, for example pH, concentration and molar ratio of the monomers, solid content in the starting solution and type of additives. Further process parameters relate to process control, such as temperature and residence time, and to the design of the apparatus for carrying out the process.

The monitorable and controllable parameters are firstly the form of the resin particles. These may be present in particular as a solid sphere having a certain diameter, as a foamed or expanded particle with or without smooth surface sections or in the form of one or more particles in a common shell. Secondly, the particle diameter and particle size distribution and the porosity and hence the density are particle parameters which can be influenced.

The production of tailor-made resin particles by means of a spray condensation reduces the necessary process steps by combining the basic operations of a polycondensation with drying. The morphology of the resin particles produced can be adjusted in a targeted manner either in an integrated process step or a downstream process step or by a combination of the two steps. The morphology adjustable in this manner substantially extends the area of use of the resin particles produced and, owing to the predictability of the product properties, has a substantial advantage.

In addition, in particular by introducing certain active substances into the process sequence of the resin particle formation, these can be finely distributed and fixed in the resulting resin particles in order thus to provide an efficient functional resin particle. Substances which intervene in the generation of the morphology are not to be understood thereby in relation to the introduction. In addition, the substances forming during the polycondensation remain finely distributed in the resin particles and, when the dried resin particles are used, can have a corresponding effect, for example a biocidal effect in the case of formaldehyde.

The process comprises the provision of a starting solution which comprises at least the monomers, i.e. as a rule a condensable and crosslinkable substance with an aldehyde in a solvent. Suitable starting materials as such are those compounds which react with aldehydes and/or dialdehydes, such as glyoxal, particularly preferably formaldehyde, in a polycondensation reaction to give resins. In the process according to the invention, however, these are only those starting materials which are used in particular together with formaldehyde in the preparation of aminoplast resins, i.e. melamine, urea and substituted ureas or melamines chemically comparable therewith, which are to be included here under the term melamine or urea.

Melamine is usually used in solid form. The urea is used in solid or molten form or in the form of an aqueous solution. The formaldehyde is preferably used in the form of a 30 to 70% strength by weight aqueous solution or in the form of paraformaldehyde. All known mixing ratios may be established. In particular, from 1.2 to 6 mol of aldehyde, preferably formaldehyde, are used per 1 mol of melamine, and from 1.3 to 3 mol of aldehyde, preferably formaldehyde, per 1 mol of urea. If appropriate, from 0.01 to 0.9, preferably from 0.01 to 0.5, in particular from 0.01 to 0.3, mol of one of the other compounds which are capable of reacting with aldehydes in a polycondensation reaction can be used per 1 mol of melamine and/or urea.

The starting materials themselves can, if required, already be present in a solvent. The solvent is preferably water.

Depending on the field of use of the resin particles produced, assistants and additives which may directly influence the reaction can be used, such as
monohydric or polyhydric alcohols, e.g. methanol, ethanol, I-propanol, 2-propanol, 1-butanol, 2-butanol, tert-butanol, ethylene glycol, diethylene glycol, triethylene glycol, polyethylene glycols, butanediols, pentanediols, hexanediols, trimethylolpropane, neopentylglycol and sorbitol
amino alcohols, e.g. ethanolamine, diethanolamine and triethanolamine.

The reaction is preferably carried out in apparatuses which are also suitable for the spray drying. Such reactors are described, for example, in K. Masters, Spray Drying Handbook, 5th Edition, Longman, 1991, pages 23 to 66.

The preparation of a reactive mixture from the starting materials can be effected in a separate reactor, in a mixing zone before the spraying or directly in the spray reactor.

Depending on the starting materials, the mixing can be effected at different pH. A pH of from 6.5 to 12 is preferred for the melamine/formaldehyde condensation, whereas a pH of from 1 to 7.5 is advantageous for the urea/formaldehyde condensation; in the latter case, the rate of the condensation reaction generally increases toward lower pH.

In order to prevent premature condensation before spraying, it may be necessary to cool the reactive mixture both during the mixing and in the feed pipes and the nozzles or atomizer disks themselves. Preferred temperatures are from −40 to 30° C. It may also be necessary to increase the feed by a higher transport pressure in the pipes. If the condensation is initiated by additives and/or catalysts, these are added only shortly before the spray reactor. In order to avoid blockages in the conveying and mixing zone or in the atomization unit, it may be expedient to produce the reactive mixture in situ in the spray reactor by spraying two or more reactants one into the other.

The liquid reactive mixture is atomized in a reactor. The reactor used is one of the known spray reactors, preferably a spray tower, for example having a height of from 8 to 30, preferably from 10 to 20, meters and a diameter of, typically, from 2 to 10, preferably from 4 to 7, meters. The spray tower may consist of a plurality of sections. The atomization unit is preferably present in an upper section, which is cylindrical, while the lower section is, if appropriate, conical.

The spraying can be effected by means of one or more nozzles or by means of atomizer disks. The atomization unit with the nozzles is usually present in the upper section of the reactor. The nozzle orifices typically have a diameter of from 1 μm to 10 mm, preferably from 500 μm to 3 mm. In general, a plurality of nozzles is arranged symmetrically and distributed uniformly over the cross section of the reactor space. They are preferably arranged in an annular manner and are supplied with the reactive mixture via a common ring pipe. In industrial use, from 5 to 50 nozzles per ring pipe are usually provided, frequently from 10 to 30. Up to 20 such nozzle rings are used. The spray cones of the nozzles preferably overlap so that the total volume of the spray reactor is homogeneously covered with spray droplets. All nozzles known to a person skilled in the art are suitable Solid-cone nozzles having a spray cone in a range from 60° to 180°, preferably 90° to 120°, are preferred. The throughput per nozzle is typically up to 1500, preferably from 100 to 500, kg/h. The pressure before spraying can be adjusted within a wide range. The spraying can be effected at atmospheric pressure or at a superatmospheric pressure of, for example, from 60 to 100 bar.

Droplet generation by laminar jet disintegration, as described in Rev. Sci. Instr. 38 (1966), pages 502 to 506, is also possible. In droplet generation by vibration droplet generation, the droplet diameter is about 1.9 times the nozzle diameter.

The spraying of the starting solution or drop formation therefrom produces drops having a controllable size. The droplets typically have a diameter of from 1 μm to 2 mm, preferably from 5 μm to 1 mm. The droplet size can be adjusted by means of the diameter of the nozzle orifice or by means of the diameter of the holes of the atomizer disks and the operating parameters of the atomization unit. Furthermore, the size of the droplets is dependent on the pressure of the reactive mixture.

The reactive starting materials condense, i.e. react, with one another within the drops in a corresponding reaction atmosphere. The reaction atmosphere and the residence time of the drops are adapted to the respective condensation conditions and the desired end product. The residence time must be sufficiently long to achieve a desired degree of condensation. The rate of the reaction is of the order of magnitude of the rate of the vaporization process and the residence time in the reactor.

The residence time is determined, inter alia, by the flow conditions prevailing in the reactor. Thus, the atomized reaction mixture can fall downward with or without gas flow. By corresponding process design, for example by countercurrent flow of the driving or accompanying gas used, the speed of fall can be reduced, the direction of flow can be reversed or, if required, the drops can be kept in suspension. Thus, the residence time can be established as desired. Preferably, the gas flows in the direction of fall. The gas velocity is established so that the flow in the reactor is directed so that no convection eddies opposing the general direction of flow occur. Residence times of from 5 to 150, preferably from 30 to 120, seconds are established.

The driving gas or accompanying gas removes solvent and uncondensed starting materials. Air or other inert gases or gases which catalytically influence the reaction (such as carbon dioxide or sulfur dioxide or stack gas) or mixtures of said gases can be used. Preferably, dry air is heated to a temperature of from 100 to 200° C., preferably from 140 to 180° C. The heat of reaction can be withdrawn from the gas emerging from the reactor, and the liquid fractions separated off thereby and consisting of solvent and starting materials can be fed back to the reactive mixture.

The absolute pressure in the reactor is preferably from 0.001 to 20, in particular from 0.1 to 10, bar. Usually, condensation is effected at atmospheric pressure. The temperature in the reactor is preferably from 0 to 300° C., in particular from 20 to 200° C. The reactors can additionally be heated in order to avoid a condensation on the reactor wall. The wall temperature is at least 5° C. above the temperature in the interior of the reactor.

The temperature during the spray condensation is usually constant. In some applications, it may be expedient for a temperature profile to prevail inside the reactor.

As a rule, the product of a spray condensation is a solid spherical particle which can be separated from the gas phase. The reaction product can be removed from the reactor in a conventional manner, preferably at the bottom via a screw conveyor, or can be separated from the gas stream by a cyclone or filter. The powder obtained can then be discharged by means of paddle units or screw conveyors. The resulting diameters of the resin particles are typically from 1 μm to 2 mm, preferably from 5 μm to 1 mm, particularly preferably from 30 to 500 μm.

In order to establish a desired morphology of the resin particles, it is necessary to create conditions (take measures) which lead to a transformation within the resin particle, which, starting from a drop, would otherwise harden in general to a solid sphere during the polycondensation process.

The morphology transformation is initiated by carrying out the process appropriately, in particular by a temperature program during the spray condensation in the spray reactor, by a targeted thermal after-treatment in a further process step and/or by the addition of additives in the starting solution or solutions. Preferred additives are blowing agents, for example organic solvents or thermally decomposable compounds, which, under the prevailing reaction conditions, produce gaseous decomposition products which lead to an expansion of the resin particles. Further preferred additives are surface-active substances (surfactants) which can influence the resulting foam structure in a targeted manner. A thermal after-treatment in a separate process, in particular in a drying stage, is preferred.

A resin particle having a certain proportion of residual moisture or unconverted starting material or incompletely evaporated solvent at the exit of the spray reactor is preferably transferred into a downstream apparatus in which the desired physical or chemical modification of the product is effected. The absolute residual moisture content in the resin particle produced is in particular in a range from 0 to 30% and the residual reactivity is from 0 to 80% of the initial value, before the morphology transformation. Here, residual reactivity is intended to be understood as meaning the specific heat of reaction of the resin particles, measurable, for example, by means of DSC (differential scanning calorimetry) and based on the specific heat of reaction of the starting solution.

The modification of the product is carried out in an apparatus which is suitable for thermal drying and may have different designs known to a person skilled in the art. Suitable process variants are evaporative, contact or radiant drying or high-frequency drying. The thermal after-treatment is preferably effected by subjecting the resin particles to a temperature typically from 100 to 200° C. The after-treatment is effected during a residence time of from 1 second to 1 hour, depending on the energy input and the desired foam structure. Resin particle morphologies which can be established are a solid sphere or a particle having a closed generated surface, for example a shell, whose thickness is from 1 to 20% of the particle diameter, having a particle diameter of, in particular, from 30 to 500 μm. A foamed resin particle with or without smooth surface sections is preferred, it being possible for the smooth surface sections to extend substantially over the total surface or to account for only a small part of the surface. If smooth surface sections are absent, a particle which is porous throughout and may have virtually a spherical shape or another form is present. A further morphology which can be established is a shell having a diameter of from 30 to 500 μm, with which further smaller resin particles of an order of magnitude of from 10 to 50 μm have agglomerated. The foamed resin particles may have closed-cell and/or open-cell foam structures (for example, reticulated foams) whose spatial structures (for example, pores, cells, strut lengths) typically have dimensions of from 0.1 to 200 μm.

In the first process step of the spray condensation, depending on the acid content of the reactive mixture and the process conditions, a shell which has different thickness and encloses a core of a certain residual moisture content and residual reactivity forms. In a further drying step, the particles foam and expand depending on the acid content. At low acid content, no change in the solid sphere occurs. Only with increasing acid content do the resin particles begin to foam, the smooth surface bursting open and it being possible for anything up to a complete flaking off and exposure of a porous hollow body to occur.

Low temperatures, for example from 0 to −100° C., during an after-treatment step cause the smooth surface shell surrounding the particles to flake off so that a porous hollow body is exposed.

The resin particles can be further processed to particle agglomerates by methods known to a person skilled in the art (integrated in the spray reactor or as a downstream unit).

Tailor-made resin particles are widely used. Resin powders are preferably used as organic pigments. However, it is only the controllable foaming of the resin particles which leads to an enhanced pigment effect owing to the higher light refraction in the pores.

Furthermore, the novel melamine or urea resins or the mixture thereof can be used as a filler for very light injection molding or extrusion materials by controlled foaming and the density reduction achieved thereby. Owing to the refractive index difference in the pores of the foamed resin particle compared with the surrounding matrix polymer (for example polystyrene or polyacrylates), the fillers simultaneously act as a pigment.

Active substances which are components of the starting solutions are incorporated in finely divided form and fixed in the resulting resin matrix during the condensation process. Thus, depending on the character of the active substances, functional fillers or coating materials form, which are used, for example, as a filler, retention aid or pigment (e.g. white pigment with UV brightener) in papermaking.

The active substances added to the starting solution can subsequently be liberated by diffusion or breaking of the resin particles. The gases which are present in the cavities and pores and result from the condensation process have, for example in the case of formaldehyde, a biocidal effect.

Foamed resin particles are suitable as insulating material, for example for heat insulation.

The controlled morphology transformation by means of an after-treatment proves advantageous if it is effected only at the location of the further processing of the resin particles, for example on introduction of the resins as filler into injection molding or extrusion materials.

The resin particles, preferably the foamed resin particles, can advantageously be used as cleaning agents. The application can be carried out in the form of a powder, of granules, of a suspension, as a coating of a molding or in embedded form in a matrix.

1.-10. (canceled)

11. A spray condensation process for the preparation of dried resins in powder form from melamine, urea or a mixture thereof and at least one aldehyde, wherein the carrying out of the spray condensation is effected by droplet generation and thereby the morphology of the resin particles produced is influenced in a targeted manner with respect to their particle parameters in the powder produced, a foamed, predominantly spherical particle with or without smooth surface sections being produced.

12. The process according to claim 11, wherein the droplet generation is a vibration droplet generation.

13. The process according to claim 11, wherein the adjustment of the pH in the starting solution of the components before the spray condensation influences in a targeted manner the morphology of the resin particles produced with respect to their particle parameters.

14. The process according to claim 11, wherein active substances are added to the starting solution of the components before the beginning of the spray condensation.

15. The process according to claim 11, wherein additives which form gases or vapors during the spray condensation or after the latter has been carried out or which, as surface-active substances, influence the resulting foam structure are added to the starting solution of the components before the beginning of the spray condensation.

16. The process according to claim 11, wherein the morphology of the resin particles produced is influenced in a targeted manner with respect to their particle parameters by a temperature profile during the spray condensation or after the latter has been carried out.

17. The process according to claim 11, wherein the resin particles produced are subjected to a drying stage downstream of the spray condensation.

18. A resin particle obtained by the process according to claim 11.

19. An organic pigment, filler or cleaning agent which comprises the resin particle according to claim 18.

20. A carrier of active substances which comprises the resin particle according to claim 18.
